(19) United States
(12) Patent Application Publication
(10) Pub. No.: US 2026/0213033 A1
(43) Pub. Date: Jul. 23, 2026

(54) MULTI-LAYER BETAVOLTAIC BATTERY USING PEROVSKITE COMPOUND AND MANUFACTURING METHOD THEREOF

(71) Applicants: Jong Hwan JANG, Gyeonggi-do (KR); Dong Chan KIM, Gyeonggi-do (KR)

(72) Inventors: Jong Hwan JANG, Gyeonggi-do (KR); Dong Chan KIM, Gyeonggi-do (KR)

(21) Appl. No.: 19/449,940

(22) Filed: Jan. 15, 2026

(30) Foreign Application Priority Data
Jan. 21, 2025 (KR) 10-2025-0008548

(51) Int. Cl. G21H 1/06

(52) U.S. Cl. CPC G21H 1/06

(57) ABSTRACT

The present disclosure discloses a betavoltaic battery using a perovskite compound, comprising: internal electrodes including a plurality of internal anodes and a plurality of internal cathodes alternately arranged, wherein at least one of the internal anodes and the internal cathodes includes a radioisotope that emits beta rays; perovskite compound layers disposed between each of the internal anodes and the internal cathodes; an external anode connected to the plurality of internal anodes; an external cathode connected to the plurality of internal cathodes; and a radiation shielding layer surrounding an outer periphery of the battery, excluding at least a portion of the external anode and the external cathode. According to the present invention, since the perovskite compound layers and the internal electrodes can be alternately stacked up to hundreds of layers, it is possible to provide a betavoltaic battery with high energy density and maximized capacity relative to its volume.

### CROSS-REFERENCE TO RELATED APPLICATION

This application claims the benefit and priority to Korean Patent Application No. 10-2025-0008548, filed on Jan. 21, 2025. The entire disclosure of the application identified in this paragraph is incorporated herein by reference.

### FIELD

The present invention relates to a betavoltaic battery, and more particularly, to a multi-layer betavoltaic battery with improved energy density and efficiency by alternately stacking perovskite compound layers and radiation sources.

### BACKGROUND

Atomic batteries convert energy generated during the nuclear decay process of radioisotopes into electrical energy. Since they can produce stable power over a long period regardless of the surrounding environment, they have received significant attention in fields such as aerospace, military, and unmanned exploration.

Nuclear batteries are broadly classified, depending on the energy conversion method, into radioisotope thermoelectric generators (RTGs) that use radioactive decay heat, and betavoltaic batteries that utilize beta rays generated during beta decay.

Among them, a betavoltaic battery generates electric power by a semiconductor with a PN junction structure absorbing beta rays emitted from a radioisotope. Specifically, electron-hole pairs, generated by the energy of beta rays in a depletion region (space charge region) of the PN junction, serve as a current source.

The power generation principle of a betavoltaic battery is substantially similar to that of a solar cell; however, unlike solar cells, it is minimally affected by surrounding environmental conditions such as weather or temperature. Therefore, it can stably produce electric power for an extended period even in extreme environments, such as cryogenic or high-temperature conditions.

However, conventional betavoltaic batteries exhibit significantly low power conversion efficiency. Thus, producing sufficient electric power requires an increased size, which poses a challenge for miniaturization.

### SUMMARY

The present invention has been made in view of this background, and an object thereof is to provide a solution capable of maximizing the capacity and achieving miniaturization of a betavoltaic battery.

To achieve the above object, a first aspect of the present invention provides a betavoltaic battery comprising: internal electrodes consisting of a plurality of internal anodes and a plurality of internal cathodes alternately arranged, wherein at least one of the internal anodes and the internal cathodes includes a radioisotope that emits beta rays; perovskite compound layers, each disposed between an internal anode and an internal cathode; an external anode connected to the plurality of internal anodes; an external cathode connected to the plurality of internal cathodes; and a radiation shielding layer surrounding an outer periphery of the battery, except for a portion or all of the external anode and the external cathode.

The internal electrodes of the betavoltaic battery according to the first aspect may include at least one radioisotope selected from the group consisting of Nickel-63 (⁶³Ni), Tritium (³H), and Strontium-90 (⁹⁰Sr).

Furthermore, an electrode protection layer for protecting the internal electrodes during a polishing process may be formed on an inner surface of the radiation shielding layer of the betavoltaic battery according to the first aspect.

A second aspect of the present invention provides a method for manufacturing a betavoltaic battery, comprising: preparing perovskite sheets containing a perovskite compound; manufacturing sheet-electrode units by forming a plurality of internal electrode patterns, including radioisotopes that emit beta rays, on surfaces of the perovskite sheets; manufacturing a perovskite-internal electrode laminate by stacking the plurality of sheet-electrode units such that opposite ends of vertically adjacent internal electrode patterns are offset from each other rather than being aligned on the same vertical line; cutting the perovskite-internal electrode laminate into a plurality of battery chips; and forming external anodes and external cathodes at opposite ends of the battery chips to be electrically connected to the internal anodes and internal cathodes, respectively, and forming a radiation shielding layer on an outer periphery of the battery chips.

In the manufacturing method according to the second aspect, the step of manufacturing the sheet-electrode units may include forming the plurality of internal electrode patterns by applying an internal electrode paste containing at least one selected from the group consisting of Nickel-63 (⁶³Ni), Tritium (³H), and Strontium-90 (⁹⁰Sr) onto surfaces of the perovskite sheets.

Furthermore, in the step of manufacturing the sheet-electrode units, the plurality of internal electrode patterns may be formed on both an upper surface and a lower surface of each perovskite sheet, wherein opposite ends of the internal electrode patterns respectively formed on the upper and lower surfaces are offset from each other rather than being vertically aligned.

Furthermore, after the step of cutting the perovskite-internal electrode laminate into the plurality of battery chips, a debinding process for removing binder components from the battery chips and a sintering process involving high-temperature heating may be performed.

Furthermore, in the manufacturing method, prior to the step of cutting the perovskite-internal electrode laminate into the plurality of battery chips, an electrode protection layer for protecting the internal electrodes during a polishing process may be formed on both upper and lower surfaces of the perovskite-internal electrode laminate.

Furthermore, in the manufacturing method according to the second aspect, prior to the step of cutting the perovskite-internal electrode laminate into the plurality of battery chips, radiation shielding sheets may be coupled to both upper and lower surfaces of the perovskite-internal electrode laminate.

In the step of forming the radiation shielding layer on the outer periphery of the battery chips, a first conductive shielding layer and a second conductive shielding layer spaced apart from each other may be formed at opposite sides relative to a center of each battery chip, and a non-conductive shielding layer may be formed in a space between the first and second conductive shielding layers and over the first and second conductive shielding layers.

Furthermore, in the step of forming the radiation shielding layer on the outer periphery of the battery chips, the shielding layer may be formed using at least one material selected from the group consisting of aluminum (Al), copper (Cu), lead (Pb), and plastic.

According to the present invention, since hundreds of perovskite compound layers and internal electrodes can be alternately stacked, it is possible to provide a betavoltaic battery exhibiting high energy density and maximized capacity-to-size ratio.

### BRIEF DESCRIPTION OF THE DRAWINGS

FIG. 1 is a cross-sectional view of a betavoltaic battery according to an embodiment of the present invention;

FIG. 2 is a flowchart illustrating a method for manufacturing a betavoltaic battery according to a first embodiment of the present invention;

FIG. 3 is a flowchart illustrating a method for manufacturing a perovskite sheet;

FIG. 4 is a view illustrating a sheet-electrode unit in which internal electrode patterns are formed on a perovskite sheet;

FIG. 5 is a cross-sectional view illustrating an embodiment of a sheet-electrode unit;

FIG. 6 is a cross-sectional view illustrating another embodiment of a sheet-electrode unit;

FIG. 7 is a cross-sectional view illustrating a perovskite-internal electrode laminate;

FIG. 8 is a cross-sectional view illustrating the perovskite-internal electrode laminate having an electrode protection layer formed on an outer periphery thereof;

FIG. 9 is a view illustrating a process of cutting the perovskite-internal electrode laminate into individual battery chips;

FIG. 10 is a cross-sectional view of a cut individual battery chip;

FIG. 11 is a cross-sectional view illustrating a modified embodiment of a radiation shielding layer;

FIG. 12 is a flowchart illustrating a method for manufacturing a betavoltaic battery according to a second embodiment of the present invention;

FIG. 13 is a cross-sectional view illustrating a state in which radiation shielding sheets are coupled to upper and lower surfaces of the perovskite-internal electrode laminate;

FIG. 14 is a view illustrating the cutting of the laminate of FIG. 13 into individual battery chips;

FIG. 15 is a cross-sectional view of a betavoltaic battery manufactured by the manufacturing method according to the second embodiment of the present invention.

### DETAILED DESCRIPTION

Hereinafter, preferred embodiments of the present invention will be described in detail with reference to the accompanying drawings.

For reference, in the present specification, when an element is referred to as being ‘connected,’ ‘coupled,’ or ‘communicating’ with another element, it encompasses not only a case of being directly connected, coupled, or communicating with the other element, but also a case of being indirectly connected, coupled, or communicating with the other element with one or more intervening elements therebetween. Additionally, when an element is ‘directly connected’ or ‘directly coupled’ to another element, it implies that no other element is interposed therebetween.

Furthermore, it should be understood that the term ‘including’ or ‘comprising’ a certain component does not exclude other components, but rather signifies that additional components may be further included or provided unless specifically stated to the contrary. Additionally, directional expressions such as ‘front,’ ‘rear,’ ‘left,’ ‘right,’ ‘upper,’ and ‘lower’ are relative concepts used for convenience of description and may vary depending on a viewing position; therefore, the scope of the present invention is not limited by these terms.

Moreover, in the drawings attached to the present specification, certain features may be illustrated out of scale or in an exaggerated manner for convenience of description and understanding; therefore, the scope of the present invention should not be narrowly construed or distorted based on such illustrations.

### 1. Betavoltaic Battery Using a Perovskite Compound

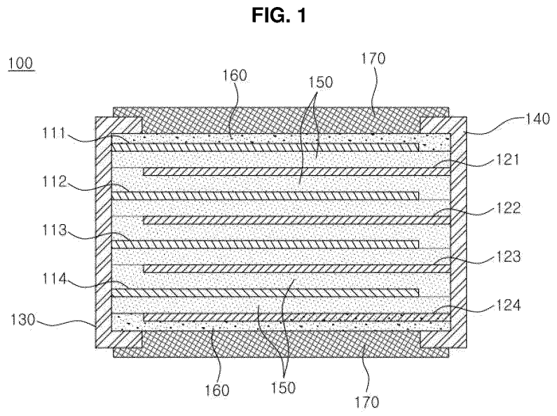

As illustrated in the cross-sectional view of FIG. 1, a betavoltaic battery 100 according to an embodiment of the present invention includes: a plurality of internal electrodes (111, 112, 113, 114, 121, 122, 123, 124) and a plurality of perovskite compound layers 150 alternately stacked; an external anode 130 and an external cathode 140 respectively formed at opposite ends of a perovskite-internal electrode laminate; and a radiation shielding layer 170 surrounding an outer periphery of the perovskite-internal electrode laminate.

An electrode protection layer 160 may be formed on both upper and lower surfaces of the perovskite-internal electrode laminate to prevent the exposed internal electrodes (111, 124) from being damaged during the manufacturing process. In this regard, the electrode protection layer 160 may comprise an insulating material, such as a ceramic material.

The plurality of internal electrodes are in the form of thin films having a predetermined area, and include a plurality of internal anodes (111, 112, 113, 114) electrically connected to the external anode 130 and a plurality of internal cathodes (121, 122, 123, 124) electrically connected to the external cathode 140.

The plurality of internal anodes (111, 112, 113, 114) and the plurality of internal cathodes (121, 122, 123, 124) are arranged to alternate with each other, and are preferably disposed parallel to each other.

Although the drawings illustrate four internal anodes (111, 112, 113, 114) and four internal cathodes (121, 122, 123, 124), respectively, this is intended only for convenience of description and understanding. To manufacture a high-capacity betavoltaic battery 100, it is preferable to alternately arrange hundreds of internal anodes and internal cathodes.

The internal anodes (111, 112, 113, 114) and the internal cathodes (121, 122, 123, 124) may contain a radioisotope that emits beta rays.

The internal anodes (111, 112, 113, 114) and the internal cathodes (121, 122, 123, 124) may be formed of an alloy of a radioactive material and a non-radioactive material.

The species of radioisotope used for the internal anodes (111, 112, 113, 114) and the internal cathodes (121, 122, 123, 124) is not particularly limited; for example, at least one material selected from the group consisting of Nickel-63 (⁶³Ni), Tritium (³H), and Strontium-90 (⁹⁰Sr) may be used.

The species or combination of radioisotopes used for each of the internal anodes (111, 112, 113, 114) and each of the internal cathodes (121, 122, 123, 124) may be the same as or different from each other.

Among the total internal electrodes (111, 112, 113, 114, 121, 122, 123, 124), the uppermost internal electrode and the lowermost internal electrode may be composed solely of a non-radioactive metallic material that does not emit radiation.

For example, in FIG. 1, the first internal anode 111 disposed at the uppermost layer and the fourth internal cathode 124 disposed at the lowermost layer may consist of a non-radioactive metallic material such as Cu, Ni, Au, or Pt, or an alloy selectively comprising the same.

As such, by disposing the internal electrodes made of a non-radioactive material at the uppermost and lowermost layers of the perovskite-internal electrode laminate, the non-radioactive internal electrodes partially shield the beta rays emitted from the radioactive internal electrodes, thereby improving shielding efficiency.

The perovskite compound layer 150 is a layer comprising a compound having a perovskite crystal structure, and functions to generate electron-hole pairs by absorbing energy from beta rays emitted from the internal electrodes (111, 112, 113, 114, 121, 122, 123, 124).

The specific type or structure of the perovskite compound is not particularly limited, provided that it is capable of generating electron-hole pairs upon exposure to beta rays.

For example, a metal-halide-based perovskite compound represented by Chemical Formula 1 below may be used.

### [Chemical Formula 1]

ABX₃ (wherein A is Cs, B is Pb, and X is I, Br, or Cl)

While it is also possible to use an organic-inorganic hybrid perovskite compound employing organic materials such as CH₃NH₃ or HC(NH₂)₂ for A, particular attention is required as such organic materials exhibit poor stability upon exposure to beta rays.

In addition, oxide-based perovskite compounds, copper-halide-based perovskite compounds, rare-earth-halide-based perovskite compounds, or the like may be used.

For example, the oxide-based perovskite compound may be selected from the group consisting of:
(1) (Ba, Sr)BO₃ (wherein B is Ti, Zr, Nb, or Ta)
(2) (La, Ba)BO₃ (wherein B is Mn, Co, Fe, or Ni)
(3) (La, Sr)BO₃ (wherein B is Cu, Co, Ti, or Zn)
(4) (Ba, K)BO₃ (wherein B is Cu, or Bi)

In the above notation, each pair in parentheses, such as (Ba, Sr), (La, Ba), (La, Sr), and (Ba, K), is intended to mean any one of the following three compositions: the first element, the second element, or a combination thereof.

In addition, the copper-halide-based perovskite compound may be selected from the group consisting of the following:
(1) A₂CuX₃ (wherein A is Li, Na, K, Rb, or Cs; and X is F, Cl, Br, or I)
(2) ACu₂X₃ (wherein A is Li, Na, K, Rb, or Cs; and X is F, Cl, Br, or I)
(3) A₃Cu₂X₅ (wherein A is Li, Na, K, Rb, or Cs; and X is F, Cl, Br, or I)

In addition, the rare-earth-halide-based perovskite compound may be selected from the group consisting of the following:
(1) AB₂X₅ (wherein A is Li, Na, K, Rb, or Cs; B is La, Ce, Pr, Nd, Pm, Sm, Eu, Gd, Tb, Dy, Ho, Er, Tm, Yb, or Lu; and X is F, Cl, Br, or I)
(2) ABX₃ (wherein A is Li, Na, K, Rb, or Cs; B is La, Ce, Pr, Nd, Pm, Sm, Eu, Gd, Tb, Dy, Ho, Er, Tm, Yb, or Lu; and X is F, Cl, Br, or I)

The radiation shielding layer 170 is configured to shield radiation (beta rays) emitted from the internal anodes (111, 112, 113, 114) and the internal cathodes (121, 122, 123, 124), and the material thereof is not particularly limited provided that it exhibits radiation shielding properties.

For example, the radiation shielding layer 170 may be formed of a metallic material such as aluminum (Al), copper (Cu), or lead (Pb), or a plastic material such as polyethylene, either alone or in any combination thereof.

Since the external anode 130 and the external cathode 140 are configured to be in direct contact with a load, they may be comprised of a material having high electrical conductivity, such as Cu, Ni, Au, or Pt.

A plating layer comprising Ni, Sn, or the like may be formed on the surfaces of the external anode 130 and the external cathode 140.

### 2. Method for Manufacturing a Betavoltaic Battery

### First Embodiment

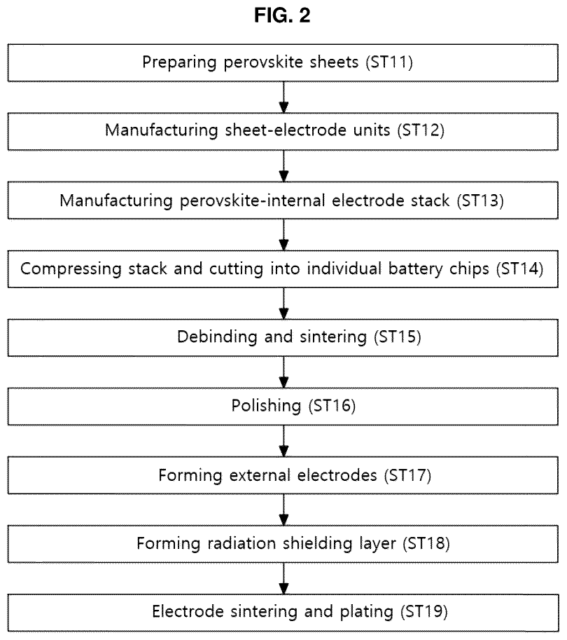

Hereinafter, a method for manufacturing a betavoltaic battery according to the first embodiment of the present invention will be described with reference to the flowchart in FIG. 2.

First, a thin sheet comprising a perovskite compound (hereinafter referred to as a “perovskite sheet”) is fabricated.

The thickness of the perovskite sheet is not particularly limited. However, in view of the radiation (beta ray) energy absorption efficiency and the subsequent stacking process, the thickness of the perovskite sheet is preferably in the range of several micrometers to several tens of micrometers (um).

The method for manufacturing the perovskite sheet is not particularly limited.

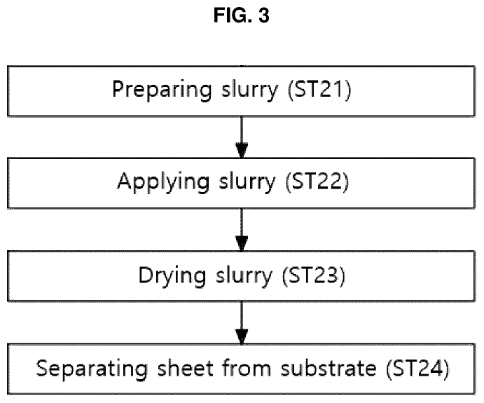

For example, as illustrated in the flowchart of FIG. 3, the perovskite sheet may be fabricated through the following steps: preparing a perovskite compound powder, a binder, and a solvent, and mixing them to form a slurry (ST21); thinly and uniformly coating the slurry onto a prepared substrate (ST22); drying the coated slurry (ST23); and separating (or delaminating) the perovskite sheet from the substrate after the drying process is complete (ST24).

The solvent and binder employed in the slurry preparation step (ST21) may be appropriately selected based on the specific type of perovskite compound utilized.

The substrate onto which the slurry is applied may be appropriately selected in consideration of the types of perovskite compound powder, binder, solvent, and other components.

For example, a film comprised of polyethylene terephthalate (PET), polypropylene (PP), or polyethylene (PE) may be used as the substrate, but the present invention is not limited thereto, and films made of other materials may also be employed.

In the step of coating the slurry onto the substrate (ST22), it is preferable to utilize a roll coater; however, the coating method is not necessarily limited to this specific apparatus or technique.

To facilitate the release of the dried perovskite sheet from the substrate, a release coating layer having a lower surface energy than the substrate may be formed on the surface of the substrate (ST11).

After manufacturing a plurality of perovskite sheets through step ST11, internal electrode patterns are formed on a surface of each perovskite sheet to fabricate sheet-electrode units 50.

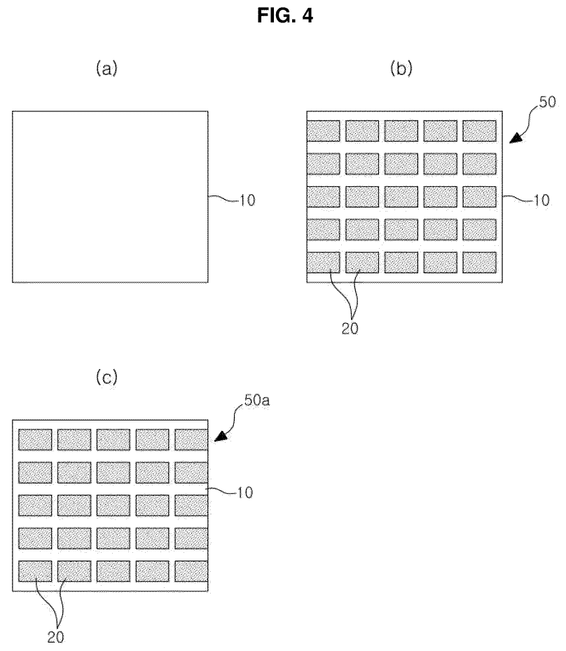

Specifically, as illustrated in (a) and (b) of FIG. 4, the sheet-electrode unit 50, having a plurality of internal electrode patterns 20 arranged thereon, is fabricated by applying an internal electrode paste onto the surface of the perovskite sheet 10 in a predetermined pattern.

The internal electrode paste comprises a mixture of a radioisotope emitting beta rays, a binder, and a solvent. As previously described, the radioisotope may include one or more selected from the group consisting of Nickel-63 (⁶³Ni), Tritium (³H), and Strontium-90 (⁹⁰Sr).

However, a paste for forming the uppermost and lowermost internal electrodes among the internal electrodes may be composed solely of non-radioactive materials, excluding any radioisotopes.

There is no particular limitation on the method for forming the internal electrode patterns 20. For example, the internal electrode patterns 20 may be formed on a surface of the perovskite sheet 10 by screen printing using the internal electrode paste, or may be formed by various other deposition or printing techniques.

The thickness of the internal electrode pattern 20 is not particularly limited; however, it should be configured to have an appropriate thickness capable of emitting a sufficient amount of beta rays into the interior of the perovskite sheet 10.

Meanwhile, as shown in FIG. 1, the internal anodes (111, 112, 113, 114) must be kept out of contact with the external cathode 140, and the internal cathodes (121, 122, 123, 124) must be kept out of contact with the external anode 130.

Therefore, it is preferable that the opposite ends of the internal anodes (111, 112, 113, 114) and the internal cathodes (121, 122, 123, 124) are arranged in a staggered (or offset) manner so that they do not align on the same vertical axis when stacked.

To this end, when forming the array of internal electrode patterns 20, it is preferable to offset the array toward one side (e.g., the left side) with respect to the centerline of the perovskite sheet 10, as illustrated in FIG. 4(b).

By forming it in this manner, rotating the sheet 10 by 180 degrees causes the array of internal electrode patterns 20 to be offset toward the opposite side (e.g., the right side) with respect to the centerline of the sheet, as illustrated in FIG. 4(c).

Accordingly, by alternately stacking the sheet-electrode unit 50 of FIG. 4(b) and the sheet-electrode unit 50a of FIG. 4(c), the ends of vertically adjacent internal electrodes become staggered (or offset) from each other, rather than aligning on the same vertical line.

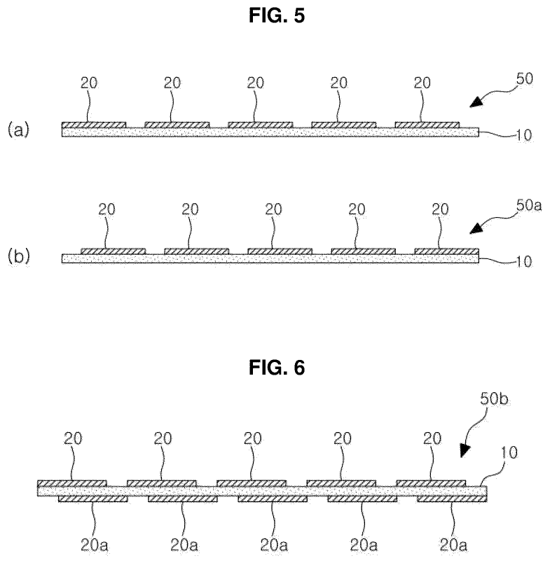

FIG. 5(a) illustrates a cross-sectional view of the sheet-electrode unit 50 shown in FIG. 4(b), and FIG. 5(b) illustrates a cross-sectional view of the sheet-electrode unit 50a shown in FIG. 4(c).

Meanwhile, although the above description focuses on forming the internal electrode patterns 20 only on the upper surface of the perovskite sheet 10, internal electrode patterns 20 and 20a may be formed on both the upper and lower surfaces of the perovskite sheet 10, as in the sheet-electrode unit 50b of FIG. 6, depending on the requirements.

In this case, it is preferable that the ends of the internal electrode pattern 20 formed on the upper surface and the ends of the internal electrode pattern 20a formed on the lower surface are arranged to be offset from each other so that they are not coincident on the same vertical line.

The sheet-electrode unit 50b, which includes the internal electrode patterns 20 and 20a formed on the upper and lower surfaces of the perovskite sheet 10, respectively, may be disposed at the lowermost layer of the perovskite-internal electrode laminate 90.

Additionally, the internal electrode pattern 20 formed on the upper surface of the perovskite sheet 10 may comprise a radioisotope, whereas the internal electrode pattern 20a formed on the lower surface may be composed solely of non-radioactive materials (ST12).

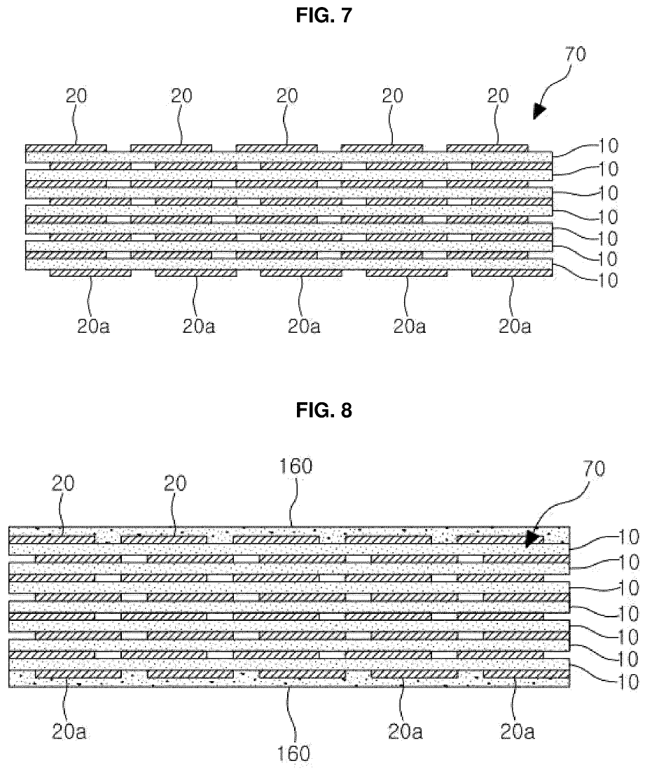

Following the fabrication of the sheet-electrode units (50, 50a, 50b) through the aforementioned processes, they are laminated (or stacked) to produce a perovskite-internal electrode laminate 70, as illustrated in FIG. 7.

To manufacture the perovskite-internal electrode laminate 70, the sheet-electrode unit 50b, which has the internal electrode patterns 20 and 20a formed on both the upper and lower surfaces of the perovskite sheet 10, is disposed at the lowermost position. Subsequently, the sheet-electrode units 50 and 50a, each having the internal electrode pattern 20 formed as a single layer, are alternately laminated on top of the unit 50b.

When alternately stacking the sheet-electrode units 50 and 50a, it is essential that the ends of the internal electrodes 20 and 20a, which are adjacent to each other with the perovskite sheet 10 interposed therebetween, are arranged in a staggered manner to avoid being aligned on the same vertical line.

The number of sheet-electrode units (50, 50a) included in the perovskite-internal electrode laminate 70 is not particularly limited; however, it is preferable to stack hundreds of layers or more to enhance energy density and maximize volumetric capacity.

Following the fabrication of the perovskite-internal electrode laminate 70, an electrode protection layer 160 may be formed on the upper and lower surfaces of the laminate 70, as illustrated in FIG. 8. The electrode protection layer 160 may be composed of an insulating material, such as ceramic (ST13).

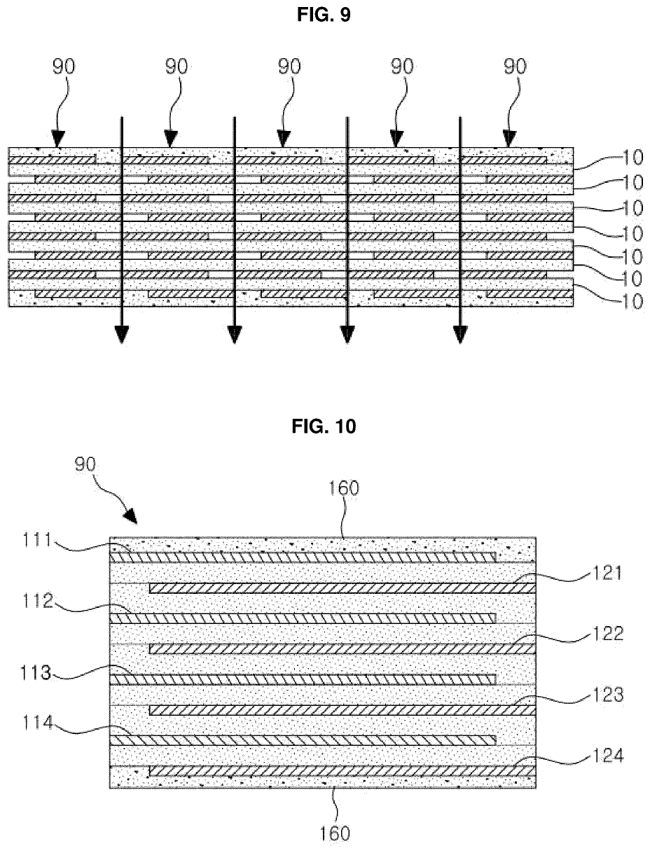

After fabricating the perovskite-internal electrode laminate 70, the laminate 70 is compressed using a press or similar equipment to enhance its density, and subsequently diced (or cut) into individual battery chips 90, as illustrated in FIGS. 9 and 10 (ST14 ).

Subsequently, a debinding process is performed on the diced battery chips 90 to remove the organic binders used during the perovskite slurry preparation. The debinding process may involve calcination, where the battery chips 90 are heated at high temperatures to decompose and eliminate the binder components.

After completing the debinding process, a sintering process is conducted by heat-treating the battery chips 90 at a high temperature (e.g., 1,000° C. or higher). This process allows the particles within the chips to coalesce uniformly, resulting in enhanced densification and structural integrity (ST15).

Then, a polishing process may be performed to enhance the contact property between both ends of the battery chip 90 and the external electrodes (130, 140).

For example, when the battery chips 90 and polishing media are placed into a rotating barrel and rotated, the sharp edges of the battery chips 90 are smoothed, thereby enhancing the contact area and connectivity with the external electrodes.

Forming the electrode protection layer 160 on the upper and lower surfaces of the perovskite-internal electrode laminate 70 prior to the polishing process can prevent damage to the internal electrodes during the polishing stage (ST16).

Next, external electrodes are formed by applying a conductive material, such as copper (Cu), to both ends of the battery chip 90. The external electrode formed at one end of the battery chip 90 is electrically connected to the internal anodes (111, 112, 113, 114) to serve as an external anode 130. Similarly, the external electrode formed at the other end is electrically connected to the internal cathodes (121, 122, 123, 124) to serve as an external cathode 140 (ST17).

Subsequently, a radiation shielding layer 170 is formed around the circumference of each battery chip 90. In this regard, it is preferable not to dispose the radiation shielding layer 170 on the outer surfaces of the external anode 130 and the external cathode 140. However, if the external electrodes (130, 140) and the radiation shielding layer 170 are composed of the same material, the radiation shielding layer 170 may also be formed on the outer surfaces of the external electrodes (130, 140).

The radiation shielding layer 170 may be formed using a metallic material, such as aluminum (Al), copper (Cu), or lead (Pb), or a polymer material, such as polyethylene.

The radiation shielding layer 170 may be formed by stacking two or more types of materials. Furthermore, the radiation shielding layer 170 may be configured as a composite or a hybrid structure by employing both conductive and non-conductive materials.

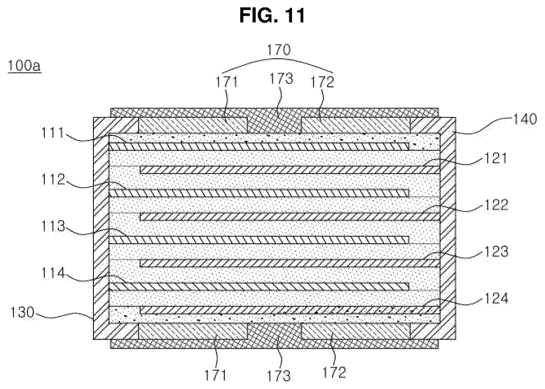

For example, as illustrated in FIG. 11, a first conductive shielding layer 171 composed of a conductive material may be formed on one side relative to the center of the battery chip 90, while a second conductive shielding layer 172 is formed on the opposite side. In this configuration, it is preferable that the first and second conductive shielding layers 171 and 172 are physically spaced apart from each other to prevent an electrical short circuit between the external electrodes (130, 140).

A non-conductive shielding layer 173 may be formed in the gap between the first and second conductive shielding layers (171, 172) as well as on their upper surfaces (ST18).

After forming the radiation shielding layer 170 on each battery chip 90, an electrode sintering process of heating at a high temperature may be performed so that the external anode 130 and the external cathode 140 can exhibit electrical characteristics.

Then, a plating layer using Ni, Sn, or the like may be formed on the surfaces of the external electrodes (130, 140) to enable stable bonding when the betavoltaic battery 100 is mounted on a substrate (ST19).

Meanwhile, in the manufacturing method according to the first embodiment of the present invention, some processes may be performed in an order different from that shown in FIG. 2, if necessary.

As an example, the process of forming the external electrodes (ST17) and the process of forming the radiation shielding layer (ST18) may be performed in the reverse order. As another example, the process of forming the radiation shielding layer 170 and the sintering process for the external electrodes (130, 140) may also be performed in the reverse order.

### Second Embodiment

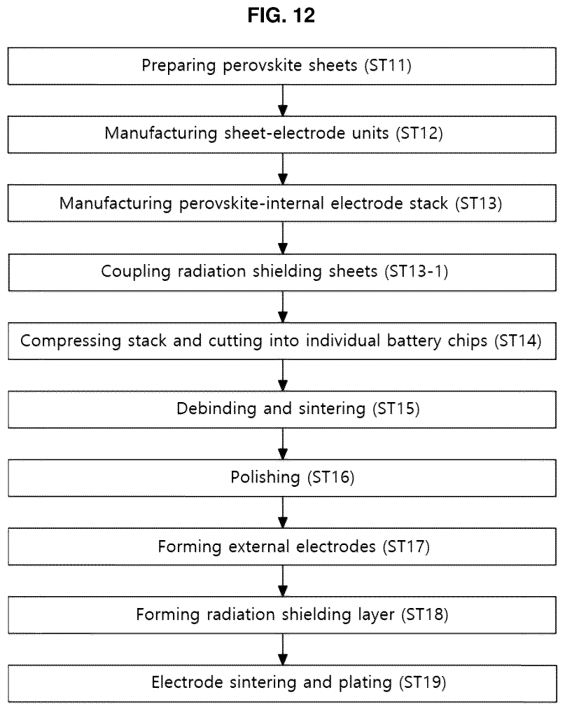

Hereinafter, a method for manufacturing a betavoltaic battery according to a second embodiment of the present invention will be described with reference to the flowchart of FIG. 12.

The process sequence according to the second embodiment of the present invention is substantially the same as that of the first embodiment, except for a difference in that a process (ST13-1) of bonding radiation shielding sheets 170a to the upper and lower surfaces of the perovskite-internal electrode laminate 70 is added after the process (ST13) of manufacturing the laminate 70.

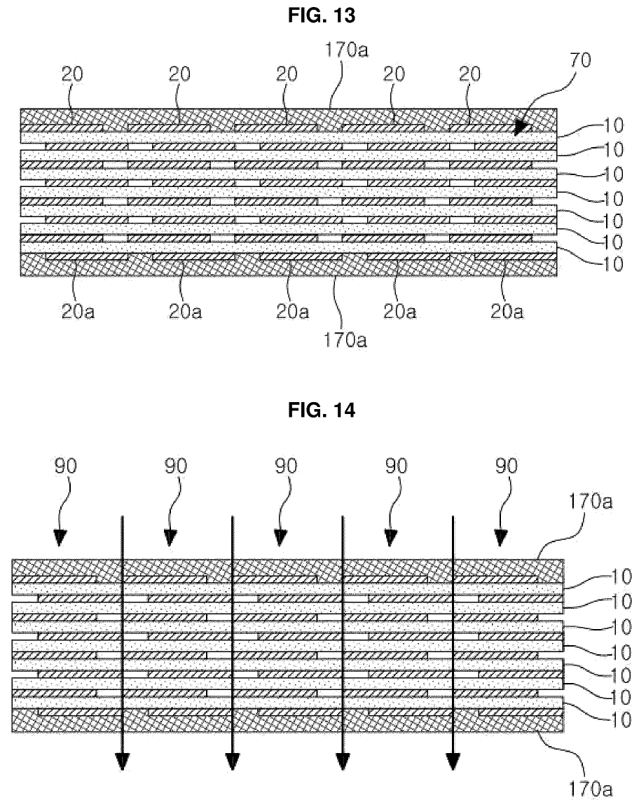

That is, after manufacturing the perovskite-internal electrode laminate 70 of FIG. 7, a process of coupling the radiation shielding sheets 170a to the upper and lower surfaces of the laminate 70 is added, as illustrated in FIG. 13.

By coupling the radiation shielding sheets 170a in this manner, there is an advantage in that radiation shielding performance can be enhanced for the upper and lower surfaces of the battery chip 90, where a large amount of beta rays is emitted.

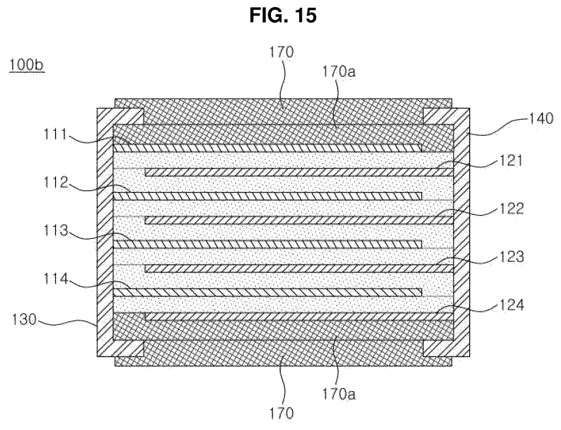

Specifically, after cutting into individual battery chips 90 as shown in FIG. 14, if a radiation shielding layer 170b is once more formed on the periphery of the battery chip 90 in step ST18, double-layered radiation shielding layers (170a, 170b) are formed on the upper and lower surfaces of the battery chip 90 as illustrated in FIG. 15, thereby shielding radiation more effectively.

While preferred embodiments of the present invention have been described above, the present invention may be implemented in various modified or altered forms during the specific application process. It should be understood that such modified or altered embodiments also fall within the scope of the present invention, provided they include the technical spirit of the present invention as disclosed in the accompanying claims.

### DESCRIPTION OF REFERENCE NUMERALS

10: Perovskite sheet
20: Internal electrode pattern
50, 50a, 50b: Sheet-electrode unit
70: Perovskite-internal electrode laminate
90: Battery chip
100: Betavoltaic battery
111, 112, 113, 114: Internal anode
121, 122, 123, 124: Internal cathode
130: External anode
140: External cathode
150: Perovskite compound layer
170: Radiation shielding layer
170a: Radiation shielding sheet
171, 172: Conductive shielding layer
173: Non-conductive shielding layer

What is claimed is:

1. A betavoltaic battery, comprising:
internal electrodes including a plurality of internal anodes and a plurality of internal cathodes alternately arranged, wherein at least one of the internal anodes and the internal cathodes includes a radioisotope that emits beta rays;
perovskite compound layers disposed between each of the internal anodes and the internal cathodes;
an external anode connected to the plurality of internal anodes;
an external cathode connected to the plurality of internal cathodes; and
a radiation shielding layer surrounding an outer periphery of the battery, excluding at least a portion of the external anode and the external cathode.

2. The betavoltaic battery of claim 1, wherein the internal electrodes include at least one radioisotope selected from the group consisting of Nickel-63 (⁶³Ni), Tritium (³H), and Strontium-90 (⁹⁰Sr).

3. The betavoltaic battery of claim 1, wherein the perovskite compound layers include a perovskite compound represented by the following chemical formula: ABX₃, wherein A is Cs, B is Pb, and X is I, Br, or Cl.

4. The betavoltaic battery of claim 1, wherein the perovskite compound layers include at least one perovskite compound selected from the group consisting of:
(Ba, Sr)BO₃, wherein B is Ti, Zr, Nb, or Ta;
(La, Ba)BO₃, wherein B is Mn, Co, Fe, or Ni;
(La, Sr)BO₃, wherein B is Cu, Co, Ti, or Zn; and
(Ba, K)BO₃, wherein B is Cu or Bi,
wherein (Ba, Sr), (La, Ba), (La, Sr), and (Ba, K) each represent Ba, the second element, or a combination thereof.

5. The betavoltaic battery of claim 1, wherein the perovskite compound layers include at least one perovskite compound selected from the group consisting of:
A₂CuX₃, ACu₂X₃, and A₃Cu₂X₅,
wherein A is Li, Na, K, Rb, or Cs, and X is F, Cl, Br, or I.

6. The betavoltaic battery of claim 1, wherein the perovskite compound layers include at least one perovskite compound selected from the group consisting of:
AB₂X₅; and ABX₃,
wherein A is Li, Na, K, Rb, or Cs; B is La, Ce, Pr, Nd, Pm, Sm, Eu, Gd, Tb, Dy, Ho, Er, Tm, Yb, or Lu; and X is F, Cl, Br, or I.

7. The betavoltaic battery of claim 1, wherein an electrode protection layer for protecting the internal electrodes during a polishing process is formed on an inner side of the radiation shielding layer.

8. A method of manufacturing a betavoltaic battery, comprising:
preparing perovskite sheets containing a perovskite compound;
forming a plurality of internal electrode patterns containing a radioisotope that emits beta rays on at least one surface of each of the perovskite sheets to manufacture sheet-electrode units;
stacking a plurality of the sheet-electrode units such that both ends of vertically adjacent internal electrode patterns are not positioned on the same vertical line to manufacture a perovskite-internal electrode laminate;
cutting the perovskite-internal electrode laminate into a plurality of battery chips; and
forming external anodes and external cathodes at both ends of each battery chip to be connected to internal anodes and internal cathodes, respectively, and forming a radiation shielding layer on an outer periphery of each battery chip.

9. The method of claim 8, wherein manufacturing the sheet-electrode units comprises applying an internal electrode paste containing at least one radioisotope selected from the group consisting of Nickel-63 (⁶³Ni), Tritium (³H), and Strontium-90 (⁹⁰Sr) onto a surface of the perovskite sheets to form the plurality of internal electrode patterns.

10. The method of claim 8, wherein manufacturing the sheet-electrode units comprises forming the plurality of internal electrode patterns on both an upper surface and a lower surface of each perovskite sheet, such that both ends of the internal electrode patterns formed on the upper surface and the lower surface are not positioned on the same vertical line.

11. The method of claim 8, wherein after cutting the perovskite-internal electrode laminate into the plurality of battery chips, a debinding process for removing binder components contained in the battery chips and a sintering process for heating the battery chips at a high temperature are performed.

12. The method of claim 8, wherein before cutting the perovskite-internal electrode laminate into the plurality of battery chips, an electrode protection layer for protecting internal electrodes during a polishing process is formed on an upper surface and a lower surface of the perovskite-internal electrode laminate.

13. The method of claim 8, wherein before cutting the perovskite-internal electrode laminate into the plurality of battery chips, radiation shielding sheets are coupled to an upper surface and a lower surface of the perovskite-internal electrode laminate.

14. The method of claim 8, wherein forming the radiation shielding layer on the outer periphery of the battery chips comprises:
forming a first conductive shielding layer and a second conductive shielding layer spaced apart from each other on opposite sides relative to a center of each battery chip; and
forming a non-conductive shielding layer in a space between the first conductive shielding layer and the second conductive shielding layer and on upper portions of the first and second conductive shielding layers.

15. The method of claim 8, wherein forming the radiation shielding layer on the outer periphery of the battery chips comprises forming the shielding layer using at least one material selected from the group consisting of aluminum (Al), copper (Cu), lead (Pb), and plastic.
